(19) United States
(12) Patent Application Publication
(10) Pub. No.: US 2022/0398290 A1
(43) Pub. Date: Dec. 15, 2022

(54) SYSTEM AND METHOD FOR IMAGE FILE GENERATION USING A WEB BROWSER

(71) Applicant: Dell Products L.P., Round Rock, TX (US)

(72) Inventors: Vishnu Sudhakaran, Bangalore (IN); Jitendra Kumar, Bangalore (IN); Anuroop Kande, Telangana (IN); Rajeshkumar Ichchhubhai Patel, Bangalore (IN)

(21) Appl. No.: 17/383,834

(22) Filed: Jul. 23, 2021

(30) Foreign Application Priority Data
Jun. 10, 2021 (IN) 202111025906

(51) Int. Cl. G06F 16/957; G06F 16/958; G06F 16/583

(52) U.S. Cl. CPC G06F 16/9574; G06F 16/9577; G06F 16/958; G06F 16/583

(57) ABSTRACT

A method for generating an image file includes: receiving, via a web browser, an image file generation request to generate the image file for a folder storing data; generating, by the web browser and in response to receiving the image file generation request, a folder template including metadata of the folder; generating, by the web browser, a shell of the image file using the folder template; fetching, by the web browser and in response to generating the shell, copies of portions of the data stored in the folder and converting the fetched copies into chunks of the image file; and generating, via the web browser and using the folder template, the image file by writing the chunks of the image file into the shell.

### BACKGROUND

Conventionally, creating an image file of a local folder using a web browser requires the entire contents (i.e., all of the data) of the local folder to be uploaded and stored in the browser memory (i.e., random access memory (RAM)/browser cache). However, the browser memory is limited and may not be able to accommodate larger-sized folders (i.e., folders storing larger amounts of data). Furthermore, heavy use of the browser memory slows down the overall performance of the browser. As a result, additional tools and/or applications are required to be downloaded to locally convert larger-sized folders into the image file. However, users still wish to be able to create image files for folders of all sizes solely through the web browser without these additional tools and/or applications.

### SUMMARY

In general, certain embodiments described herein relate to a method for generating an image file including: receiving, via a web browser, an image file generation request to generate the image file for a folder storing data; generating, by the web browser and in response to receiving the image file generation request, a folder template comprising metadata of the folder; generating, by the web browser, a shell of the image file using the folder template; fetching, by the web browser and in response to generating the shell, copies of portions of the data stored in the folder and converting the fetched copies into chunks of the image file; and generating, via the web browser and using the folder template, the image file by writing the chunks of the image file into the shell.

In general, certain embodiments described herein relate to a non-transitory computer readable medium (CRM) comprising computer readable program code, which when executed by a computer processor enables the computer processor to perform a method for generating an image file. The method includes: receiving, via a web browser, an image file generation request to generate the image file for a folder storing data; generating, by the web browser and in response to receiving the image file generation request, a folder template comprising metadata of the folder; generating, by the web browser, a shell of the image file using the folder template; fetching, by the web browser and in response to generating the shell, copies of portions of the data stored in the folder and converting the fetched copies into chunks of the image file; and generating, via the web browser and using the folder template, the image file by writing the chunks of the image file into the shell.

In general, certain embodiments described herein relate to a system including: a memory storing a local folder; and a processor coupled to the memory. The processor is configured to execute a web browser and: receive, via the web browser, an image file generation request to generate the image file for a folder storing data; generate, by the web browser and in response to receiving the image file generation request, a folder template comprising metadata of the folder; generate, by the web browser, a shell of the image file using the folder template; fetch, by the web browser and in response to generating the shell, copies of portions of the data stored in the folder and converting the fetched copies into chunks of the image file; and generate, via the web browser and using the folder template, the image file by writing the chunks of the image file into the shell.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a system in accordance with one or more embodiments.

FIG. 1.2 shows a diagram of an example folder template in accordance with one or more embodiments.

FIG. 1.3 shows a diagram of an image file shell in accordance with one or more embodiments.

FIGS. 2.1-2.2 show flowcharts of an image file generation process in accordance with one or more embodiments.

FIG. 2.3 shows a flowchart of a folder template generation process in accordance with one or more embodiments.

FIG. 2.4 shows a flowchart of an image file shell population process in accordance with one or more embodiments.

FIGS. 3.1-3.2 show an implementation example in accordance to one or more embodiments.

FIG. 4 shows a computer system in accordance to one or more embodiments.

### DETAILED DESCRIPTION

Specific embodiments will now be described with reference to the accompanying figures.

In the below description, numerous details are set forth as examples of embodiments described herein. It will be understood by those skilled in the art, that have the benefit of this Detailed Description, that one or more embodiments described herein may be practiced without these specific details and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components.

Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

One or more embodiments disclosed is directed to a system and method for generating image files using HyperText Markup Language version 5 (HTML5). The image file may be, but is not limited to, in an optical disc image (ISO image) or a disk image file (IMG file) format. In particular, rather than uploading the entire content of a local folder into a browser's browser memory (i.e., random access memory (RAM)/browser cache), only the metadata of the local folder is uploaded (e.g., using HTMLInputElement.webkitdirectory). The browser then uses the local folder's metadata to build a shell of the image file (i.e., an image file shell) including the folder's file structure (i.e., the folder's boot, file allocation, and root directory regions). In particular, the metadata of the local folder provides a flat file structure that may be converted into a tree format with root as the main folder. Using this tree, the local folder's root directory region is generated and cluster numbers are allocated for all the files and sub-folders contained in the local folder. Using this cluster allocation, a FAT (File Allocation Region) of the local folder containing one or more file allocation tables may be generated and various variables in the boot sector region may be filled.

In one or more embodiments disclosed, once the image file shell is generated, it is saved by the browser into a local storage (e.g., a local folder) of the computing device executing the browser. The browser will then initiate a retrieval of chunks of the actual data in the folder and save (using a browser download scheme) the chunks into the image file shell to generate a completed image file. To initialize a download scheme of for retrieving and saving the data chunks, the browser creates a proxy web server to simulate a dummy web page such that the system will be tricked into thinking that the chunks were retrieved and being downloaded from an external source (e.g., an external server). In particular, the dummy web page will create a separate data writing stream for saving the retrieved data chunks into the image file shell. The functions of the proxy web server can be implemented in a background thread of the browser using a conventional web worker (i.e., a web application programming interface (web API) configured to execute web browser scripts in a background thread of a web browser). This advantageously results in the image file generation being done completely within the web browser environment (i.e., no data will be sent to tools and/or applications outside of the web browser context to generate the image file locally on the computer device). Furthermore, no data will be sent to an external source (i.e., an external server, another computing device, etc.) on the network for the creation of the image file.

Additionally, in one or more embodiments disclosed, each chunk of the actual folder data retrieved may be equal to or less than 50 megabytes (MB). Alternatively, each chunk of the actual folder data retrieved may have a size that does not affect the current operations of a web browser (e.g., does not slow down the current processes being executed in parallel by the web browser). Furthermore, each of these data chunks may be appended with a header such that the browser can direct these data chunks to the proxy web server. Even further, a data chunk is not retrieved until a previously retrieved data chunk has been completely saved into the image file shell. Consequently, only a minimal amount of the browser's browser memory (i.e., ˜50 MB) is being utilized at any point in time during the image file creation process. This advantageously allows image files for larger-sized folders to be created by a browser supporting HTML5 without affecting the performance of the browser and without the need to download additional tools and/or applications to create the image files locally outside of the browser environment.

Various embodiments of the invention are described below.

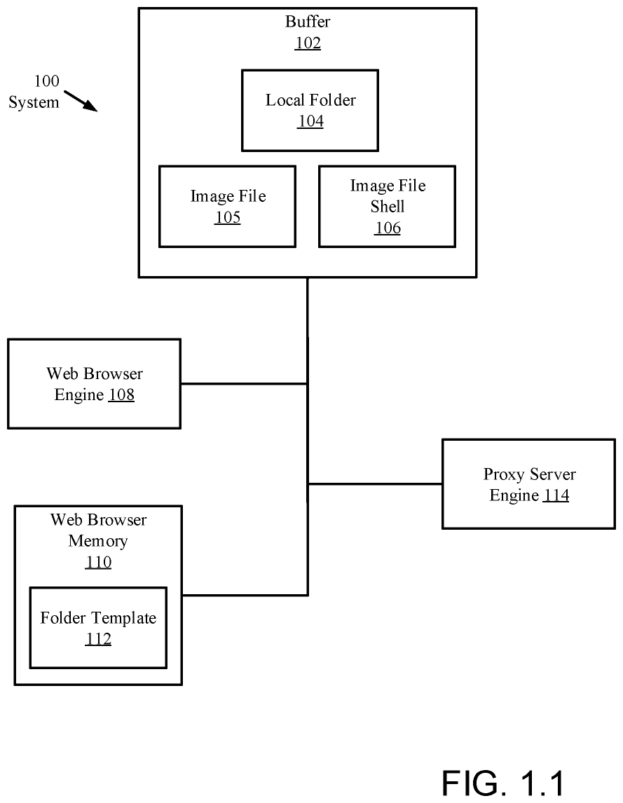

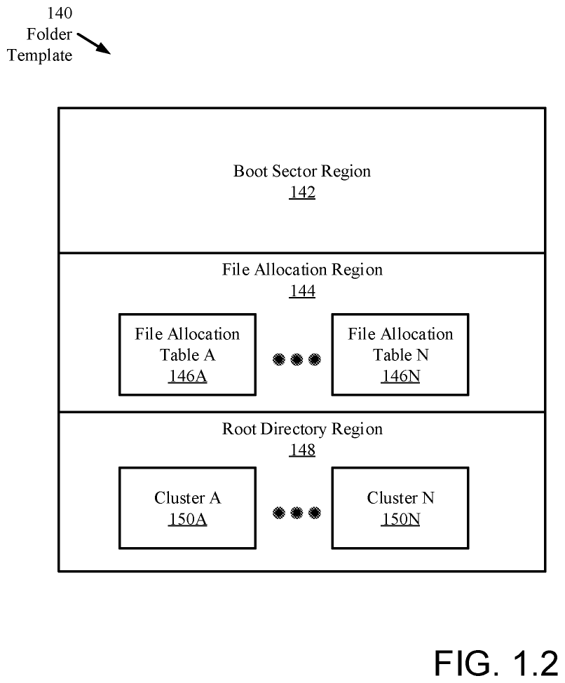

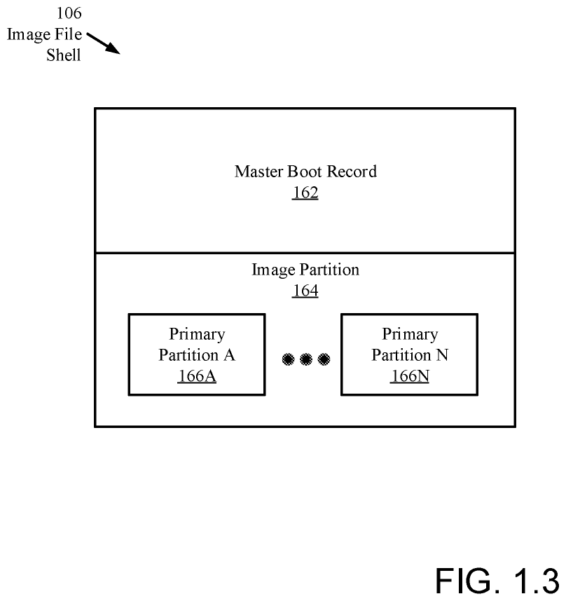

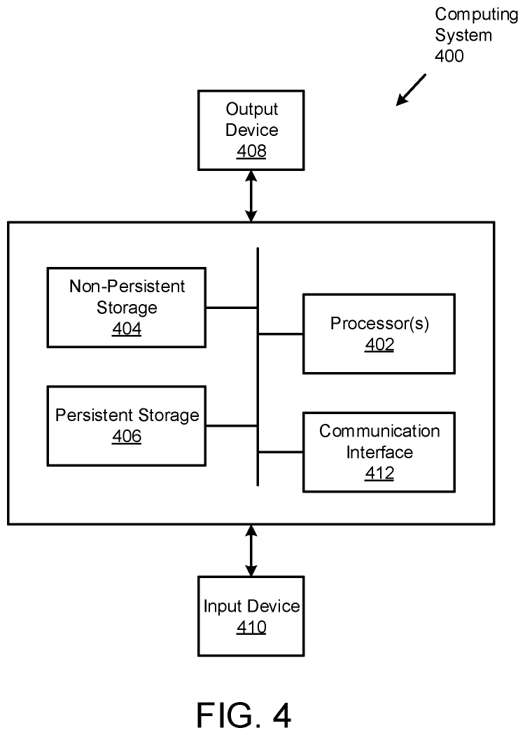

FIG. 1.1 shows a system (100) in accordance with one or more embodiments. The system includes a buffer (102), a web browser engine (108), a web browser memory (110), and a proxy server engine (114). In one or more embodiments disclosed herein, the system (100) may be part of a computing device (e.g., 400, FIG. 4). Each of these components of the system (100) will be described in more detail below.

The buffer (102) may be implemented in hardware (i.e., circuitry), software, or any combination thereof. The buffer (102) is configured to store a local folder (104), an image file (105), and an image file shell (106). The local folder (104) may be any standard folder on a computing device (i.e., a digital computer folder) capable of storing files and sub-folders. The image file (105) may be an optical disc image (ISO image) or a disk image file (IMG file) of the local folder (104) or any other digital computer folder stored in the buffer (102). The image file shell (106) may be a container (e.g., an incomplete download file, etc.) that includes a file structure of the local folder (104) to be converted into the image file (105).

The system (100) includes the web browser engine (108). The web browser engine (108) may be implemented in hardware (i.e., circuitry), software, or any combination thereof. The web browser engine (108) executes commands for running a web browser (e.g., Internet Explorer, Google Chrome, Mozilla Firefox, etc.) on a computing device.

In one or more embodiments disclosed herein, the web browser engine (108) is further configured to execute a process for generating an image file of the local folder (104) stored in the buffer (102). In one or more embodiments disclosed herein, the web browser may be supporting and executing a HyperText Markup Language 5 based (HTML5-based) environment. Although this disclosure describes the image file generation in the context of a HTML5-based web browsers, one of ordinary skill in the art would appreciate that the image file generation process of one or more embodiments may be applied to any web browsers employing other types of markup language with similar constraints.

In one or more embodiments disclosed herein, the web browser engine (108) may receive an image file generation request. The image file generation request may include information (e.g., a folder name, a folder type, a folder path in the buffer (102), a folder size, a folder creation date, a folder attribute, etc.) identifying a local folder (104) stored in the buffer (102) to be converted into the image file (105).

Once a target folder (i.e., a local folder (104)) to be converted into the image file (105) is identified, the web browser engine (108) may retrieve only the metadata of the local folder (104). In the context of this disclosure, retrieving only the metadata of the local folder (104) means that only a set of data that describes and provides information about the local folder (104) and the contents stored in the local folder (104) is retrieved. For example, only information pertaining to a file structure of the local folder (104) and information regarding the content stored in the local folder (104) (e.g., one or more data structures showing a list of file names with their corresponding paths/locations within the local folder (104)) are retrieved as the metadata. The actual data making up one or more contents (e.g., files, documents, applications, etc.) stored in the local folder (104) are not retrieved with the metadata of the local folder (104).

Additionally, in the context of this disclosure, the metadata of a content (e.g., an electronic document) in the local folder (104) refers to only the minimum amount of data (i.e., information) required for identifying properties of the electronic document. Conversely, the actual data of the document refers to all of the data (including the metadata) making up an entirety of the document. Said another way, the actual data of the document is required to execute and/or open a document and view the document contents.

In one or more embodiments disclosed herein, the metadata of the local folder (104) may be retrieved by the web browser engine (108) using one or more web application programming interfaces (web APIs). For example, a web browser supporting HTML5 may utilize the file input feature of the web browser along with the HTMLInputElement.webkitdirectory API to retrieve the metadata of the local folder (104). In particular, the HTMLInputElement.webkitdirectory is a property that reflects the webkitdirectory HTML attribute and indicates that the <input> element should let the user select directories instead of files. When a directory is selected, the directory and its entire hierarchy of contents are included in the set of selected items. The selected file system entries can be obtained using the webkitEntries property.

In one or more embodiments disclosed herein, the web browser engine (108) generates a folder template (112) using the metadata of the local folder (104). The folder template (112) includes a file structure of the local folder (104) and may be generated using headers included in the metadata of the local folder (104). The headers may represent each main component of a local folder's (104) file structure. For example, for a local folder (104) employing a structure based on a file allocation table (FAT) file system, the headers in the metadata may include a header for each of a boot sector region, a FAT region, and a root directory region of the local folder (104). An example of a folder template is shown in FIG. 1.2.

The web browser engine (108) generates the folder template (112) by first converting the file structure of the local folder (104) included in the metadata into a tree format with a root information of the local folder (104) as the main folder. This root information is used to generate the root directory region of the folder template (112). Once the root directory region is generated, the web browser engine (108) allocates cluster numbers to the metadata of each content (e.g., files, documents, sub-folders, applications, etc.) stored in the local folder (104). This cluster allocation is used by the web browser engine to generate the file allocation region of the folder template (112) and to fill in various variables in the boot sector region of the folder template (112).

In one or more embodiments disclosed herein, the folder template (112) is stored in the web browser memory (110). The web browser memory (110) is the random access memory (RAM) of a computing system (e.g., 400, FIG. 4).

In one or more embodiments disclosed, the web browser engine (108) may use the folder template (112) to generate a shell of the image file (105) (i.e., an image file shell (106)). The image file shell (106) may be generated by converting the folder template (112) into an image file. In one or more embodiments, the image file shell (106) may be a container for storing the actual data of one or more contents of the image file (105). For example, the image file shell (106) may be a write-enabled file that is incomplete until populated with content using one or more write sequences (e.g., a write sequence for downloading files from a web browser to a local storage of a computing device). An example of an image file shell (106) is shown in FIG. 1.3. Although the example shown in FIG. 1.3 is that of an IMG file structure, one of ordinary skill in the art would appreciate that the example image file shell (106) shown in FIG. 1.3 may have a file structure of an ISO image without departing from the scope of this invention.

In the context of this disclosure, image file shell (106) is a file type that cannot be opened until all of the data required to make the image file shell (106) complete has been populated into the image file shell (106) to form a completed image file (105). For example, an image file shell (106) of a specific local folder (104) is incomplete until all of the actual data stored in the specific local folder (104) is converted into an image file format and populated into (i.e., written into) the image file shell (106) to form the complete image file (i.e., an image file (105)).

In one or more embodiments disclosed herein, using the information stored in the folder template (112), the web browser engine (108) may retrieve portions of the actual data stored in the local folder (104) (i.e., the actual data of the folder contents). The web browser engine (108) may also convert these portions of the actual data into an image file format to generate chunks of the image file (105). These chunks of the image file (105) may then be written into the image file shell (106) to complete the generation of the image file (105).

In one or more embodiments disclosed herein, web browser engine (108) may only retrieve less than or equal to 50 MBs of the actual data stored in the local folder (104) at one time. A subsequent portion of the actual data stored in the local folder (104) is not retrieved until the web browser engine (108) determines that the previously retrieved portion has been successfully converted into a chunk of the image file and populated into the image file shell (106). Consequently, in the aforementioned non-limiting embodiment, only less than or equal to 50 MBs of a computing device's RAM are being utilized at a single time during the image file generation process of one or more embodiments. Thus, other operations of the web browser and/or the computing device requiring the use of RAM space are not affected by the image file generation process of one or more embodiments.

In one or more embodiments disclosed herein, the web browser engine (108) appends a tag (e.g., a unique identifier) in a header of a data packet storing the chunk of the image file. This unique identifier is used by the web browser engine (108) as well as the other components of the web browser (i.e., the proxy server engine (114) discussed below) to identify that the chunk of the image file is intended to be written into the image file shell (106).

In one or more embodiments disclosed herein, the web browser engine (108) may instantiate a proxy web server including a dummy web page and one or more service workers (i.e., a web worker). To emulate a web browser file download scenario, the proxy web server is configured to imitate a download from an external source (e.g., an external server on the network). This may be done by hoisting the dummy web page and leveraging the web worker as a dummy server such that the web browser is tricked into thinking that the proxy web server is hoisted on an external network.

The system (100) further includes the proxy server engine (114). The proxy server engine (114) may be implemented in hardware (i.e., circuitry), software, or any combination thereof. The proxy server engine (114) may run as a background thread of the web browser being executed by the web browser engine (108) to execute operations of the dummy web page and the web workers. As discussed above, the proxy server engine (114) may serve as a faux (i.e., imitation, artificial, etc.) server hosting one or more web workers for initiating a local download sequence using the web browser. Furthermore, the web workers may enable the entire image file generation process to be moved to a background thread of the web browser to avoid blocking the main threads of the web browser. As a result, the image file generation process of one or more embodiments will not interrupt any other features of the web browser that are working in parallel with the image file generation process.

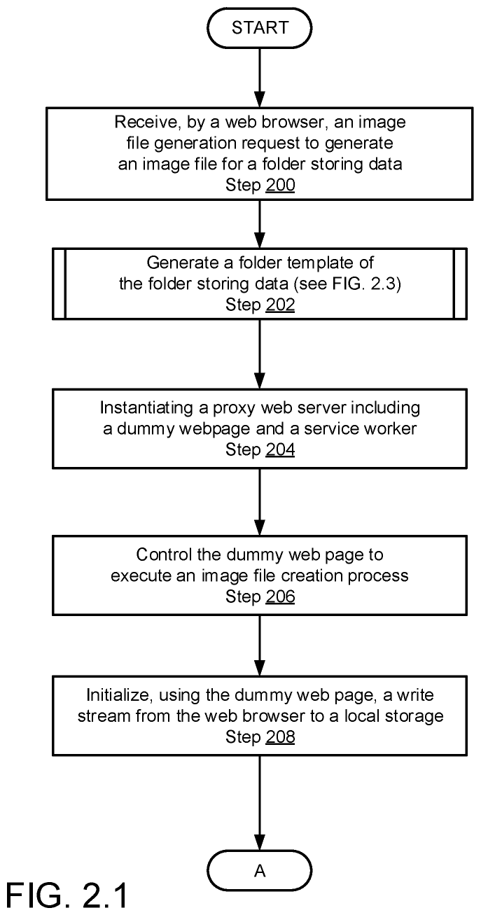

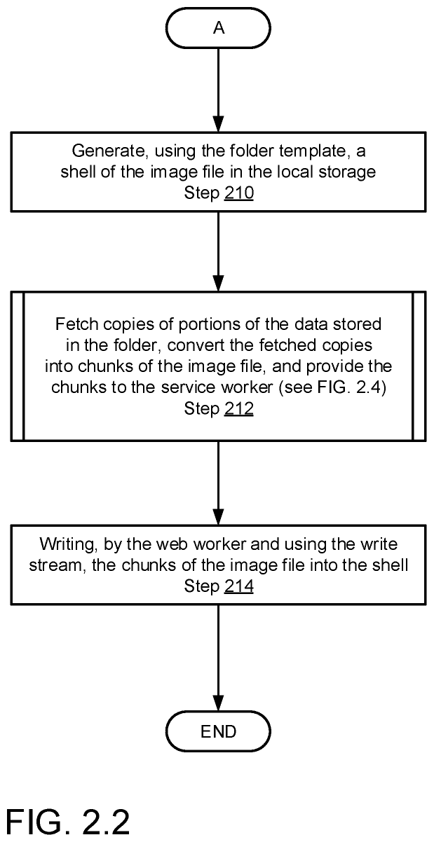

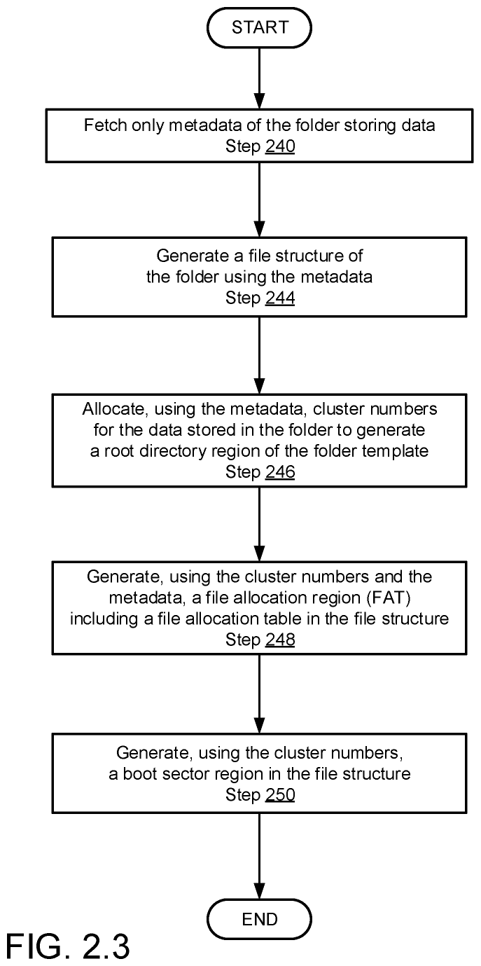

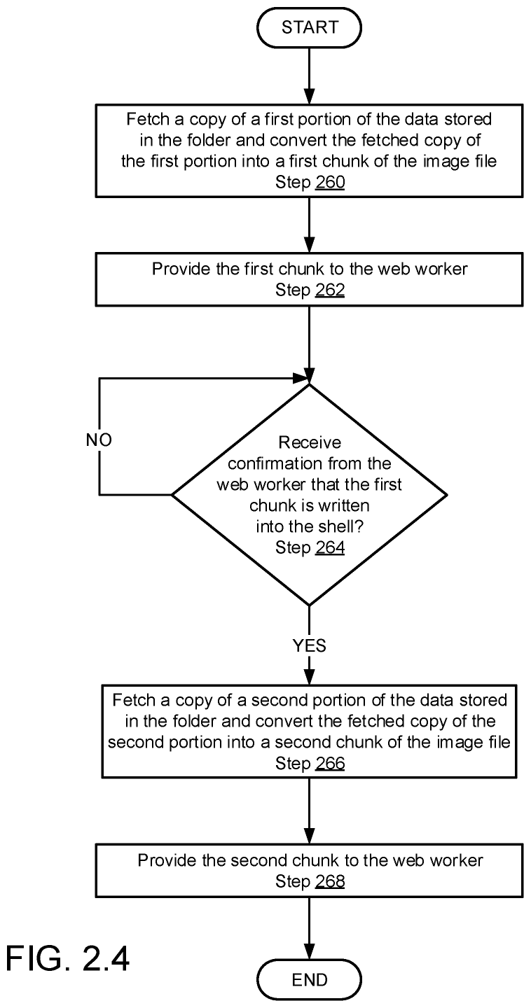

In one or more embodiments disclosed herein, using dummy web page of the proxy web server, the proxy server engine (114) initializes a write stream from the web browser to the buffer (102) for saving the image file shell (106) into the buffer (102) and for saving the chunks of the actual data stored the local folder (104) into the image file shell (106). Furthermore, the proxy server engine (114) utilizes the web workers to receive and/or intercept the converted chunks of the image file from the web browser engine (108) and write the converted chunks of the image file into the image file shell (106). This is discussed in more detail in the flowcharts of FIGS. 2.1-2.4.

Although the system (100) is shown as having four components (102, 108, 110, 112), in other embodiments of the invention, the system (100) may have more or fewer components. Further, the functionality of each component described above may be split across components. Further still, each component (102, 108, 110, 112) may be utilized multiple times to carry out an iterative operation.

Turning now to FIG. 1.2, FIG. 1.2 shows an example folder template (140) (e.g., 112, FIG. 1) in accordance with one or more embodiments. As shown in FIG. 1.2, the folder template (140) is based on a FAT file system and includes a boot sector region (142), a file allocation region (144), and a root directory region (148). Although the folder template (140) is shown to have a FAT file system, one of ordinary skill in the art would appreciate that the original local folder (e.g., 104, FIG. 1.1) used for generating the folder template (140) may utilize any other type of the file system and/or file structure.

In the example folder template (140) shown in FIG. 1.2, the root directory region includes a plurality of clusters (150A, 150N) including cluster numbers. As discussed above, the cluster numbers are allocated for all metadata of the contents (e.g., files, documents, sub-folders, applications, etc.) stored in the local folder in order to populate the file allocation region (144) and boot sector region (142) of the folder template (140).

In particular, the file allocation region (144) may be populated to include a plurality of file allocation tables (146A, 146N). Each of the these file allocation tables (146A, 146N) may be data structures (e.g., a list, a table, etc.) that maps all of the content in the local folder to their respective locations within the hierarchy of the local folder's file structure. In one or more embodiments, the file allocation region (144) may have one main file allocation table (146A) and a plurality of secondary file allocation tables (146B, 146N) for redundancy purposes.

In one or more embodiments disclosed herein, the boot sector region (142) includes information (e.g., basis input/output system (BIOS) data, partition information, etc.) that the computing device uses to access the file system of the local folder. For example, the boot sector region (142) may include a master boot record of the local folder.

Turning now to FIG. 1.3, FIG. 1.3 shows an example image file shell (106) generated using a local folder having a FAT file system. As shown in FIG. 1.3, the image file shell (106) includes a master boot record (162) and an image partition (164) storing a plurality of primary partitions (166A, 166N). In one or more embodiments disclosed herein, the master boot record (162) holds the address of each of the primary partitions (166A, 166N), their respective file systems, storage capacities, and boot capabilities. The image partition (164) stores the boot code, the actual data of the folder contents along with the file system metadata. The file system metadata includes the file allocation tables (e.g., 146A-146N, FIG. 1.2) from the folder template (e.g., 140, FIG. 1.2) and information regarding the root directory region.

Although FIG. 1.3 shows the example image file shell (106) generated based on a FAT file system, one of ordinary skill in the art would appreciate that an image file shell generated based on a different file system may include similar or different components as those shown in FIG. 1.3.

FIGS. 2.1 and 2.2 show a flowchart of a method in accordance with one or more embodiments of the invention. The method depicted in FIGS. 2.1-2.2 may be performed to generate an image file from a local folder in accordance with one or more embodiments of the invention. The method shown in FIGS. 2.1-2.2 may be performed by, for example, the web browser engine (e.g., 108, FIG. 1.1) and the proxy server engine (114, FIG. 1.1). Other components of the systems in FIG. 1.1 may perform all, or a portion, of the method of FIGS. 2.1-2.2 without departing from the invention.

While FIGS. 2.1-2.2 is illustrated as a series of steps, any of the steps may be omitted, performed in a different order, additional steps may be included, and/or any or all of the steps may be performed in a parallel and/or partially overlapping manner without departing from the invention.

In Step 200, a web browser receives an image file generation request to generate an image for a folder storing data. In one or more embodiments disclosed herein, the folder may be stored in a local storage of a computing device. Alternatively, the folder may be stored in an external storage (i.e., a universal serial bus (USB) device, an external hard drive, etc.) connected to the computing device.

In one or more embodiments disclosed herein, the folder identified within the image file generation request may be of any size. For example, the folder may have a size (e.g., 20 GB) larger than an available RAM (e.g., 4 GB) of the computing device. The folder may also contain one or more files, documents, and/or sub-folders organized in a predetermined hierarchy.

In Step 202, a folder template of the folder is generated. As discussed above, the folder template may be generated by a web browser engine of a web browser and stored in a web browser memory of the web browser. As further discussed above in reference to FIG. 1.1, in one or more embodiments, the folder template is generated using only the metadata of the folder and includes information regarding a file structure of the folder. Additional details of the folder generation step in FIG. 2.1 is discussed in more detail in FIG. 2.3.

In Step 204, a proxy web server including a dummy webpage and a web worker is instantiated. In one or more embodiments discussed herein, the proxy web server is instantiated by the web browser engine. Furthermore, to emulate a web browser file download scenario, the proxy web server is configured to imitate a download from an external source (e.g., an external server on the network). This may be done by hoisting the dummy web page and leveraging the web worker as a dummy server such that the web browser is tricked into thinking that the proxy web server is hoisted on an external network. In one or more embodiments disclosed herein, the proxy web server may have more than one web worker.

In Step 206, the dummy web page is controlled to execute an image file creation process. In one or more embodiments, the dummy web page may be controlled by the web browser engine sending commands to the proxy server engine. The proxy server engine may execute the dummy web page on a background thread of the web browser to avoid blocking the main threads of the web browser. Furthermore, executing an image file creation process may include initializing a write stream, by the dummy web page, from the web browser to a local folder (i.e., a local storage) on the computing device from which the folder is retrieved.

In Step 208, the dummy web page initializes and installs a write steam from the web browser to the local storage of the computing device. In one or more embodiment, the write steam mimics a data write sequence established during a typical web browser data download sequence (i.e., a download sequence for saving one or more documents retrieved from the web browser to a local download folder).

In Step 210, a shell of the image file (i.e., an image file shell) is generated in the local folder using the folder template and saved. In one or more embodiments, the image file shell is generated by the web browser engine in a main thread of the web browser and transmitted to the proxy server engine executing on a background thread of the web browser. The proxy server engine uses the web worker to receive the image file shell transmitted from the web browser engine and writes the image file shell (i.e., save the image file shell) into the local folder using the write steam.

In Step 212, copies of portions of the actual data stored in the folder are fetched, the fetched copies are converted into chunks of the image file, and the chunks are provided to the web worker. In one or more embodiments, the portions of the actual data stored in the folder are converted into an image file format and the chunks of the image file are appended with a unique tag in the header of the data packet encapsulating the chunks. The web browser engine uses the unique tag to identify that the chunks of the image file are to be redirected to the proxy server engine. Alternatively, or in addition to the above, the proxy sever engine may identify data packets generated by the web browser engine with the unique tag to intercept and retrieve these data packets.

As discussed above in reference to FIG. 1.1, the web browser engine may only retrieve less than or equal to 50 MBs of the actual data stored in the local folder at one time. A subsequent portion of the actual data stored in the local folder is not retrieved until the web browser engine determines that the previously retrieved portion has been successfully converted into a chunk of the image file and populated into the image file shell. Consequently, only less than or equal to 50 MBs of a computing device's RAM is being utilized at a single time during the image file generation process of one or more embodiments. Thus, other operations of the web browser and/or the computing device requiring the use of RAM space are not affected by the image file generation process of one or more embodiments. Additional details with respect to Step 212 is discussed below in FIG. 2.3

In Step 214, the chunks of the image file are written into the image file shell. In one or more embodiments, the web browser engine redirects the chunks of the image file appended with the tag to the proxy server engine. The proxy server engine utilizes the web worker to receive the chunks of the image file and writes the chunks of the image file into the image file shell. The writing of the chunks of the image file into the image file shell is completed when all of the data in the original folder has been converted and written into the image file shell.

FIG. 2.3 shows a flowchart of a method in accordance with one or more embodiments of the invention. The method depicted in FIG. 2.3 may be performed to generate a folder template using metadata of a local folder in accordance with one or more embodiments of the invention. The method shown in FIG. 2.3 may be performed by, for example, the web browser engine (e.g., 108, FIG. 1.1). Other components of the systems in FIG. 1.1 may perform all, or a portion, of the method of FIGS. 2.3 without departing from the invention.

While FIGS. 2.3 is illustrated as a series of steps, any of the steps may be omitted, performed in a different order, additional steps may be included, and/or any or all of the steps may be performed in a parallel and/or partially overlapping manner without departing from the invention.

In Step 240, the web browser engine fetches only the metadata of the folder identified in the image file generation request received in Step 200 of FIG. 2.1 discussed above.

In Step 244, a file structure of the folder is generated using the metadata. In one or more embodiments disclosed herein, the web browser engine generates the file structure using headers included in the metadata. For example, the metadata for a folder using a FAT file system may include headers for each of a boot sector region, a file allocation region, and a root directory region. The metadata information of each individual content (e.g., files, documents, applications, sub-folders, etc.) included in the root directory region may also include headers to identify each content in the folder.

In one or more embodiments, the headers included in the metadata identifying the file structure of the folder are converted into a tree format with a root information of the folder as the main folder. This root information is used to generate the root directory region of the folder template.

In Step 246, cluster numbers are allocated for the metadata identifying the content in the folder to generate a root directory region in the folder template. In particular, in one or more embodiments, once the root directory region is generated, the web browser engine allocates cluster numbers to each of the metadata specifying contents stored in the folder.

In one or more embodiments disclosed herein, this cluster allocation is used by the web browser engine to generate the file allocation region of the folder template in Step 248 and to fill in various variables in the boot sector region of the folder template in Step 250. In particular, the file allocation region includes at least one file allocation table including the names and corresponding location of each content stored in the local folder to be converted into the image file.

FIG. 2.4 shows a flowchart of a method in accordance with one or more embodiments of the invention. The method depicted in FIG. 2.4 may be performed to fetch data from a local folder to be converted and written in to an image file shell in accordance with one or more embodiments of the invention. The method shown in FIG. 2.4 may be performed by, for example, the web browser engine (e.g., 108, FIG. 1.1). Other components of the systems in FIG. 1.1 may perform all, or a portion, of the method of FIGS. 2.4 without departing from the invention.

While FIGS. 2.4 is illustrated as a series of steps, any of the steps may be omitted, performed in a different order, additional steps may be included, and/or any or all of the steps may be performed in a parallel and/or partially overlapping manner without departing from the invention.

In Step 260, as discussed above in Step 212, a copy of a first portion of the actual data stored in the local folder to be converted into an image file is fetched and converted into an image file format. The first portion fetched and converted becomes a first chunk of the image file. This first chunk is provided to the web worker to be written into the image file shell in Step 262.

In Step 264, before retrieving a subsequent portion (i.e., a second portion) of the data stored in the local folder, the web browser engine determines whether the first chunk has been successfully written into the image file shell. In one or more embodiments, the web browser engine may receive a notification from the web worker in the proxy server engine that the writing of the first chunk into the image file shell is successful. Alternatively, the web browser engine may directly monitor the actions of the web worker. If the web browser engine determines that the first chunk has not been successfully written into the image file shell (i.e., NO in Step 264), the web browser engine repeats the determination until it is determined that the writing of the first portion is completed successfully.

Once the writing of the first portion is determined to be successful (i.e., YES at Step 266), the web browser engine fetches the second portion of the content stored in the local folder in Step 266 and provides the converted second portion to the web worker to be written into the image file shell. This process discussed in FIG. 2.4 is repeated for each portion of the content stored in the local folder that is fetched by the web browser engine. In particular, the process in FIG. 2.4 ensures that only the minimally required amount of RAM resources is used by the web browser to create the image file.

For example, in the above example using the size of less than or equal to 50 MBs, only 50 MBs or less of RAM space will be utilized by the web browser at any given time during the image file creation process. This allows the remaining, unutilized portions of the RAM to be allocated for other functions of the web browser and computing device.

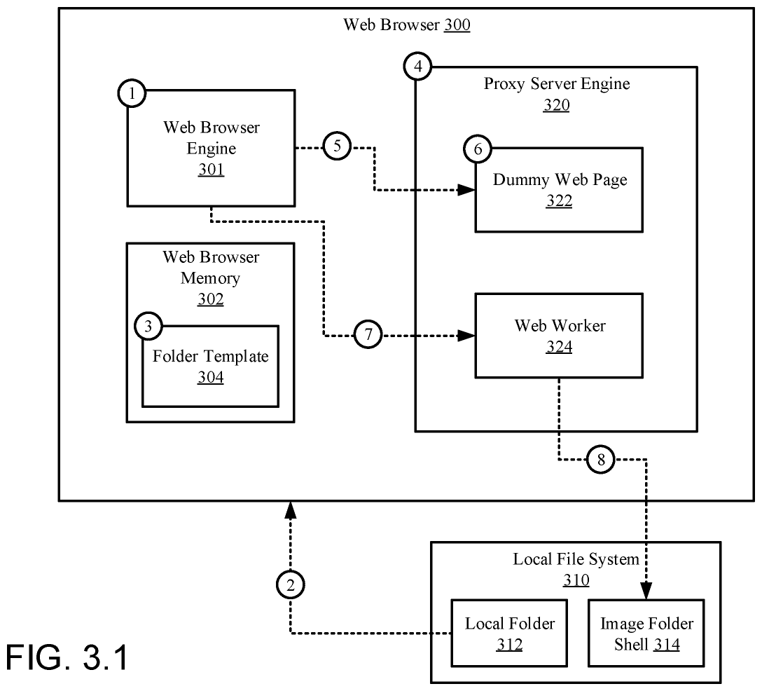

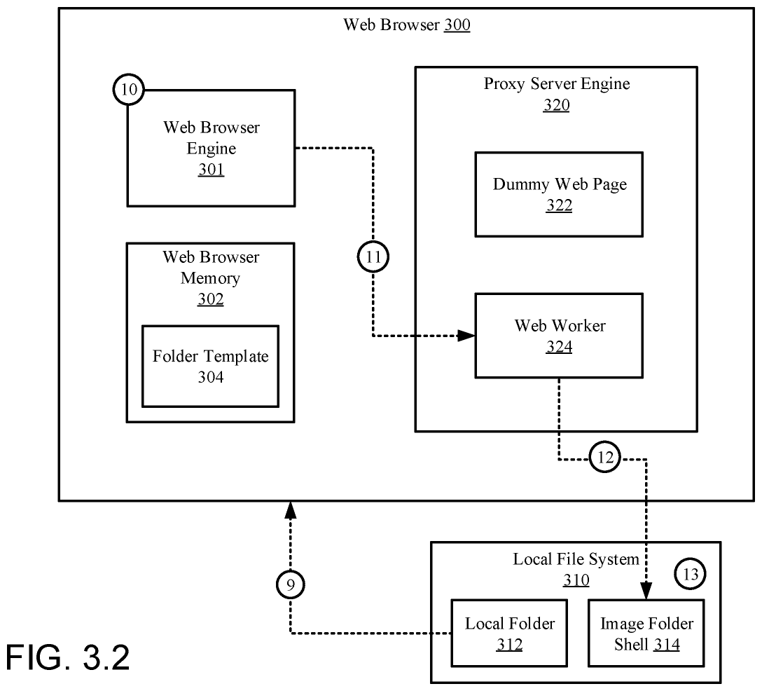

To further clarify embodiments of the invention, a non-limiting working example is provided in FIGS. 3.1-3.2.

### Beginning of Working Example

As shown in FIG. 3.1, a web browser (300) receives an image file generation request to generate an image file for local folder (312) stored in a local file system (310) [1]. The web browser (300) retrieves only the metadata of the local folder (312) without retrieving any data of the actual data stored in the local folder (312) [2]. The web browser (300) generates a folder template (304) of the local folder (312) using the metadata and stores the folder template (304) in the web browser memory (302) [3]. The web browser instantiates a proxy web server (320) including a dummy web page (322) and a web worker (324) [4].

The web browser (300) causes (i.e., programs) the dummy web page (322) to generate a write stream from the web browser (300) to the local file system (310) [5]. The dummy web page (322) generates the write stream and informs the web worker (324) of the write stream [6]. The web worker (324) receives an image folder shell (314) generated by the web browser (300) using the folder template (304) [7]. The web worker (300) saves the image folder shell (314) into the local file system (310) [8].

Turning now to FIG. 3.2, once the image folder shell (314) is saved in the local file system (310), the web browser fetches a portion of the actual data stored in the local folder (312) [9]. The fetched portion of the actual data is converted into a chunk of the image file by the web browser engine (301) [10]. The chunk of the image file is pushed to and/or intercepted by the web worker (324) [11]. The web worker (324) saves the chunk of the image file into the image folder shell (314) [12]. A completed image file (e.g., an ISO image or an IMG file) is then generated in the local file system once all of the chunks of the image file are saved into the image folder shell (314) [13].

This process (i.e., processes [9] to [13] in FIG. 3.2) of fetching portions of the actual data and saving the portions into the image folder shell (314) as chunks of the image file is repeated until all of the data in the local folder (312) has been replicated into the image folder shell (314). Once all of the data in the local folder is replicated into the image folder shell (314), the generation of the image file of the local folder (312) is completed.

### End of Working Example

FIG. 4 shows a computer system in accordance to one or more embodiments.

Embodiments disclosed herein may be implemented using computing devices. FIG. 4 shows a diagram of a computing device in accordance with one or more embodiments disclosed herein. Computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), communication interface (412) (e.g., Bluetooth interface, infrared interface, network interface, optical interface, etc.), input devices (410), output devices (408), and numerous other elements (not shown) and functionalities. Each of these components is described below.

In one embodiment disclosed herein, computer processor(s) (402) may be an integrated circuit for processing instructions. For example, the computer processor(s) may be one or more cores or micro-cores of a processor. Computing device (400) may also include one or more input devices (410), such as a touchscreen, keyboard, mouse, microphone, touchpad, electronic pen, or any other type of input device. Further, communication interface (412) may include an integrated circuit for connecting computing device (400) to a network (not shown) (e.g., a local area network (LAN), a wide area network (WAN) such as the Internet, mobile network, or any other type of network) and/or to another device, such as another computing device.

In one embodiment disclosed herein, computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to computer processor(s) (402), non-persistent storage (404), and persistent storage (406). Many different types of computing devices exist, and the aforementioned input and output device(s) may take other forms.

Embodiments disclosed herein may provide the ability to directly convert local folders stored on a computing device into image files using only a web browser. In particular, the generation of the image file can be done solely within the context of the web browser environment without requiring additional tools and/or applications to be downloaded in order to locally convert the local folders into image files. Consequently, users of the image file generation process of one or more embodiments may benefit from being able to convert local folders into image files solely using web browser (e.g., Internet Explorer) without the need to purchase or license additional tools and/or resources.

Additionally, the image file generation process of one or more embodiments is able to generate an image file for local folders of any size without sacrificing the performance of the web browser. Specifically, a web browser's performance and storage capacity is limited by the available web browser memory (i.e., random access memory (RAM)/browser cache). By generating the image file in a piece-wise manner rather than overloading the web browser memory with all of the data from the local folder to be converted, only the minimal amount of browser memory is needed for executing the image file generation. Consequently, users of the image file generation process of one or more embodiments may benefit from being able to freely select any local folder to be converted without worrying about a limit on the size of the selected folder. In particular, users with computing devices having limited RAM (e.g., 2 GB) may benefit from being able to generate local folders with a size larger than the available RAM.

Furthermore, the image file generation process of one or more embodiments reduces the amount of computer resources (namely, computing device's RAM) required for generating image files based on local folders. This advantageously improves the functionality of the computing device by reducing the amount of computer resources necessary for generating the image file and allocating the saved computer resources to other functionalities that use RAM (e.g., web browser operations, running of programs and other applications, etc.).

The problems discussed above should be understood as being examples of problems solved by embodiments of the invention and the invention should not be limited to solving the same/similar problems. The disclosed invention is broadly applicable to address a range of problems beyond those discussed herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for generating an image file, the method comprising:
receiving, via a web browser executing on a computing device, an image file generation request to generate the image file for a folder storing data;
generating, by the web browser and in response to receiving the image file generation request, a folder template comprising metadata of the folder;
generating, by the web browser, a shell of the image file using the folder template;
fetching, by the web browser and in response to generating the shell, copies of portions of the data stored in the folder and converting the fetched copies into chunks of the image file; and
generating, via the web browser and using the folder template, the image file by writing the chunks of the image file into the shell.

2. The method of claim 1, wherein
generating the image file is completed when all of the chunks making up an entirety of the data stored in the folder are written into the shell, and
the data stored in the folder comprises at least one of a file and a sub-folder.

3. The method of claim 1, wherein
the folder template comprises a file structure of the folder, and
the file structure comprises a boot sector, a file allocation region, and a root directory region of the folder.

4. The method of claim 3, wherein the writing of the chunks of the image file into the shell further comprises, by the web browser:
instantiating a proxy web server comprising a write steam from the web browser to local storage storing the shell; and
writing the chunks of the image file into the shell using the file structure of the folder and the write stream.

5. The method of claim 4, wherein the converting of the fetched copies into the chunks of the image file further comprises:
appending a tag in a header of each of the chunks, wherein the tag specifies the local storage of the computing device as a download destination of the chunks.

6. The method of claim 5, wherein
the proxy web server further comprises:
a dummy web page that initializes the write stream from the web browser to the local storage storing the shell; and
a web worker that intercepts all data uploaded to the web browser that includes the tag and writes the intercepted data into the shell, and
the web worker executes the interception and the writing of the data in a background thread of the proxy web server.

7. The method of claim 3 wherein, the generating of the folder template further comprises, by the web browser:
fetching only the metadata of the folder without fetching the copies of the data stored in the folder; and
generating the file structure of the folder using the metadata of the folder, wherein the folder template is stored in a memory of the web browser.

8. The method of claim 1, wherein
the portions of the data stored in the folder comprise at least a first portion and second portion, and
the fetching of the copies and the converting of the fetched copies into the chunks of the image file further comprises:
fetching a copy of the first portion and converting the fetched copy of the first portion into a first chunk of the image file; and
in response to the first chunk being written into the shell, fetching a copy of the second portion and converting the fetched copy of the second portion into a second chunk of the image file.

9. The method of claim 8, wherein each of the fetched copies is less than or equal to 50 megabytes (MB).

10. The method of claim 1, wherein
the web browser is a HyperText Markup Language 5 based (HTML5-based) browser, and
the image file is an optical disc image (ISO image) or a disk image file (IMG file).

11. A non-transitory computer readable medium (CRM) comprising computer readable program code, which when executed by a computer processor enables the computer processor to perform a method for generating an image file, the method comprising:
receiving, via a web browser, an image file generation request to generate the image file for a folder storing data;
generating, by the web browser and in response to receiving the image file generation request, a folder template comprising metadata of the folder;
generating, by the web browser, a shell of the image file using the folder template;
fetching, by the web browser and in response to generating the shell, copies of portions of the data stored in the folder and converting the fetched copies into chunks of the image file; and
generating, via the web browser and using the folder template, the image file by writing the chunks of the image file into the shell.

12. The CRM of claim 11, wherein
generating the image file is completed when all of the chunks making up an entirety of the data stored in the folder are written into the shell, and
the data stored in the folder comprises at least one of a file and a sub-folder.

13. The CRM of claim 11, wherein
the folder template comprises a file structure of the folder, and
the file structure comprises a boot sector, a file allocation region, and a root directory region of the folder.

14. The CRM of claim 13, wherein the writing of the chunks of the image file into the shell further comprises, by the web browser:
instantiating a proxy web server comprising a write steam from the web browser to the local storage storing the shell; and
writing the chunks of the image file into the shell using the file structure of the folder and the write stream.

15. The CRM of claim 14, wherein the converting of the fetched copies into the chunks of the image file further comprises:
appending a tag in a header of each of the chunks, wherein the tag specifies the local storage of the computer as a download destination of the chunks.

16. A system comprising:
a memory storing a local folder; and
a processor coupled to the memory, wherein the processor is configured to execute a web browser and:
receive, via the web browser, an image file generation request to generate the image file for a folder storing data;
generate, by the web browser and in response to receiving the image file generation request, a folder template comprising metadata of the folder;
generate, by the web browser, a shell of the image file using the folder template;
fetch, by the web browser and in response to generating the shell, copies of portions of the data stored in the folder and converting the fetched copies into chunks of the image file; and
generate, via the web browser and using the folder template, the image file by writing the chunks of the image file into the shell.

17. The system of claim 16, wherein
generating the image file is completed when all of the chunks making up an entirety of the data stored in the folder are written into the shell, and
the data stored in the folder comprises at least one of a file and a sub-folder.

18. The system of claim 16, wherein
the folder template comprises a file structure of the folder, and
the file structure comprises a boot sector, a file allocation region, and a root directory region of the folder.

19. The system of claim 18, wherein the writing of the chunks of the image file into the shell further comprises, by the processor and via the web browser:
instantiating a proxy web server comprising a write steam from the web browser to the local storage storing the shell; and
writing the chunks of the image file into the shell using the file structure of the folder and the write stream.

20. The system of claim 19, wherein the converting of the fetched copies into the chunks of the image file further comprises:
appending a tag in a header of each of the chunks, wherein the tag specifies the local folder as a download destination of the chunks.
